(19) United States
(12) Patent Application Publication
(10) Pub. No.: US 2009/0289097 A1
(43) Pub. Date: Nov. 26, 2009

(54) Wafer Leveling-Bonding System Using Disposable Foils

(76) Inventors: Weng-Jin Wu, Hsin-Chu (TW); Wen-Chih Chiou, Miaoli (TW); Chen-Hua Yu, Hsin-Chu (TW)

Correspondence Address: SLATER & MATSIL, L.L.P., 17950 PRESTON ROAD, SUITE 1000, DALLAS, TX, 75252, US

(21) Appl. No.: 12/124,844

(22) Filed: May 21, 2008

(51) Int. Cl. B23K 1/00

(52) U.S. Cl. 228/41

(57) ABSTRACT

A leveling-bonding method and an apparatus for performing the same are provided. The method includes providing a bond support for supporting a wafer; providing a bond head over the bond support; dispatching a foil over the wafer; placing the wafer on the bond support; and using the bond support and the bond head to apply a force on the foil and the wafer.

### TECHNICAL FIELD

This invention relates generally to integrated circuit manufacturing processes, and more particularly to apparatuses and methods for bonding semiconductor dies onto wafers.

### BACKGROUND

With the evolving of semiconductor technologies, semiconductor dies are becoming increasingly smaller. However, more functions need to be integrated into the semiconductor dies. Accordingly, the semiconductor dies need to have increasingly greater numbers of I/O pads packed into smaller areas, and the density of the I/O pads rises quickly. As a result, the packaging of the semiconductor dies becomes more difficult, adversely affecting the yield.

Package technologies can be divided into two categories. One category is typically referred to as a wafer level package (WLP), wherein dies on a wafer are packaged before they are sawed. The WLP technology has some advantages, such as a greater throughput and a lower cost. Further, less under-fill and/or molding compound is needed. However, WLP suffers from drawbacks. As aforementioned, the sizes of the dies are becoming increasingly smaller, and the conventional WLP can only be fan-in type packages, in which the I/O pads of each die are limited to a region directly over the surface of the respective die. With the limited areas of the dies, the number of the I/O pads is limited due to the limitation of the pitch of the I/O pads. If the pitch of the pads is to be decreased, solder bridges may occur. Additionally, under the fixed-ball-size requirement, solder balls must have a certain size, which in turn limits the number of solder balls that can be packed on the surface of a die.

In the other category of packaging, dies are sawed from wafers before they are packaged onto other wafers, and only “known-good-dies” are packaged. An advantageous feature of this packaging technology is the possibility of forming fan-out chip packages, which means the I/O pads on a die can be redistributed to a greater area than the die, and hence the number of I/O pads packed on the surfaces of the dies can be increased.

FIGS. 1 and 2 illustrate cross-sectional views of intermediate stages in a conventional bonding process. Referring to FIG. 1, known-good-dies 12 are pre-bonded onto wafer 10 piece by piece, wherein the bonding time is relatively short, for example, only a couple of seconds for each die. A leveling bonding then needs to be performed. A conventional leveling-bonding system used for the leveling bonding includes bond head 16 and compliant layer 14 under, and attached to, bond head 16. Compliant layer 14 has a flat surface, and is adapted to compensate for thickness variations between dies 12. During the leveling bonding, as shown in FIG. 2, bond head 16 is moved down, so that a force is applied on dies 12 through compliant layer 14. Dies 12 are thus level-bonded onto wafer 10.

The leveling-bonding system shown in FIGS. 1 and 2 suffer from drawbacks. Compliant layer 14 is attached on bond head 16, and hence may be used for a relatively long period of time before it is replaced. Overtime, in-prints and other types of defects are generated, and hence the compliance of compliant layer 14 is adversely affected, which in turn affects the reliability of the leveling-bonding process. In addition, compliant layer 14 was typically formed of rubber or other types of polymer materials, which can only endure temperatures up to about 300° C. However, some applications, such as copper-to-copper direct bonding, require temperatures higher than 300° C. The usage of the leveling-bonding system shown in FIGS. 1 and 2 are thus limited. Further, the throughput of the above-discussed bonding system is low, partially due to the relatively long time for leveling bonding each wafer.

Accordingly, what is needed in the art is a leveling-bonding system and methods for performing the leveling bonding with a high throughput and an improved reliability.

### SUMMARY OF THE INVENTION

In accordance with one aspect of the present invention, an apparatus for bonding a wafer includes a bond support for supporting the wafer; a bond head over the bond support, wherein the bond support and the bond head are configured to move relative to each other; and a foil dispatcher configured to dispatch a foil onto the wafer.

In accordance with another aspect of the present invention, an apparatus for bonding a wafer includes a bond support for supporting the wafer; a bond head over the bond support and having a surface facing the bond support, wherein the bond head is free from a polymer material; a robot handler for loading the wafer onto, and unloading the wafer from, the bond support; a foil free from adhesives on both sides, and having a size no less than a size of the wafer; and a foil dispatcher configured to dispatch the foil onto the wafer.

In accordance with yet another aspect of the present invention, an apparatus for bonding a wafer includes a bond support for supporting the wafer; a first bond head over the bond support and having a surface facing the bond support, wherein the first bond head and the bond support are configured to move relative to each other; and a second bond head over, and having a clearance from, the first bond head, wherein the clearance is adequate for placing the wafer. The first and the second bond heads are free from polymer materials, and are configured to move relative to each other. The apparatus further includes a robot handler for loading the wafer over, and unloading the wafer from, at least one of the bond support and the first bond head; and a foil dispatcher configured to dispatch a foil onto the wafer, wherein the foil is free from adhesives on both sides, and has a wafer size.

In accordance with yet another aspect of the present invention, a leveling-bonding method includes providing a bond support for supporting a wafer; providing a bond head over the bond support; dispatching a foil over the wafer; placing the wafer on the bond support; and using the bond support and the bond head to apply a force on the foil and the wafer.

In accordance with yet another aspect of the present invention, a method for leveling-bonding wafers includes providing a bond support; providing a first bond head over the bond support; providing a second bond head over the first bond head, wherein the bond support and the first and the second bond heads are configured to be movable against each other; dispatching a first foil over a first pre-bonded wafer, wherein the first pre-bonded wafer comprises first dies on a first base wafer; placing the first pre-bonded wafer between the bond support and the first bond head; dispatching a second foil over a second pre-bonded wafer, wherein the second pre-bonded wafer comprises second dies on a second base wafer; placing the second pre-bonded wafer between the first and the second bond heads; and pressing the second bond head to apply forces on the first and the second pre-bonded wafers.

The advantageous features of the present invention include greater throughput, improved reliability, and the expansion of the usage of leveling-bonding system to applications requiring high temperatures.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 illustrate cross-sectional views of intermediate stages in a bonding process using a conventional leveling-bonding system;

FIG. 3 illustrates a leveling-bonding system of the present invention;

FIG. 4 illustrates a foil dispatcher for dispatching foils onto wafers;

FIGS. 5A through 5C illustrate intermediate stages of a first leveling-bonding process, wherein a foil is dispatched onto a pre-bonded wafer before the wafer is placed onto a bond support;

FIG. 6 illustrates an intermediate stage of a second leveling-bonding process, wherein a foil is dispatched onto a pre-bonded wafer after the wafer is placed onto the bond support; and

FIGS. 7 and 8 illustrate intermediate stages of an alternative leveling-bonding process, wherein two wafers are bonded simultaneously using a leveling-bonding system having more than one stacked bond head.

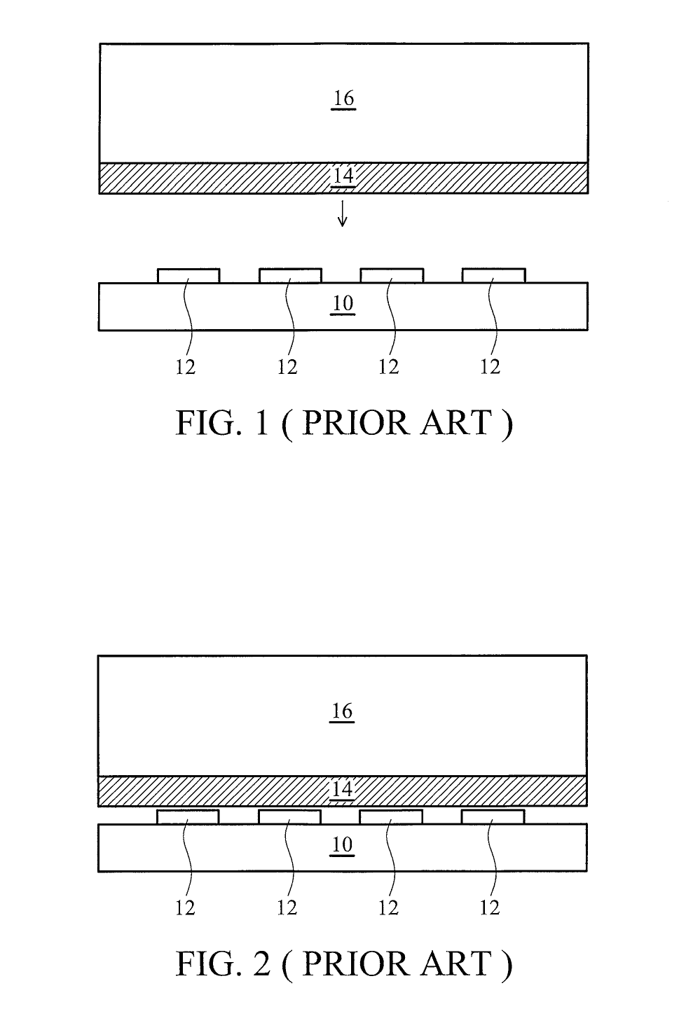

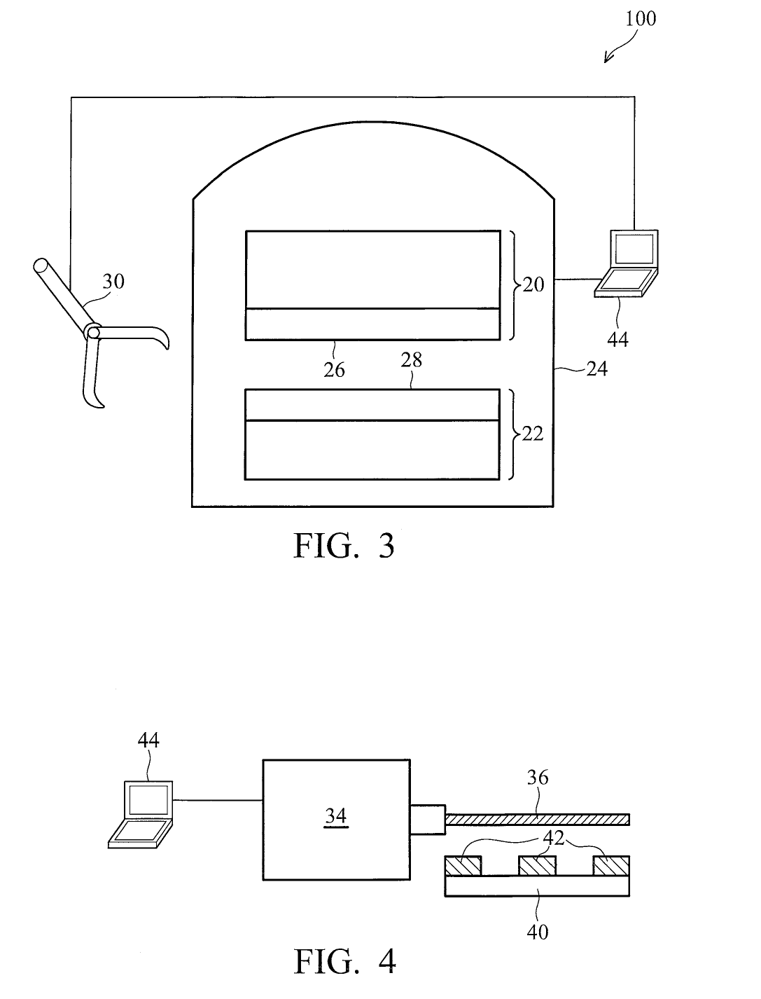

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

A novel leveling-bonding system and the methods of performing leveling-bonding processes are provided. The variations and operation of the preferred embodiments are then discussed. Throughout the various views and illustrative embodiments of the present invention, like reference numbers are used to designate like elements.

FIG. 3 schematically illustrates a part of leveling-bonding system 100, which includes bond head 20 and bond support 22. Preferably, bond head 20 and bond support 22 are in a controlled environment 24, which is capable of being filled with gases used in the leveling-bonding process, which gases include clean air, nitrogen, and the like. The controlled environment 24 may also be a bonding chamber that can be vacuumed. Bond head 20 preferably has a flat surface 26. In an embodiment, flat surface 26 has a great hardness, and is substantially free from the in-prints caused by the leveling bonding. Accordingly, bond head 20 may be formed of steel or other applicable materials. The temperature of bond head 20 can also be controlled, for example, through an internal heater (not shown), to desirable temperatures, which may be up to about 500° C., or even higher. Bond support 22 also preferably has a flat surface 28. Preferably, the temperature of bond support 22 may also be controlled to the desirable temperatures. Bond head 20 and bond support 22 have a size greater than the wafer (refer to wafer 40 in FIG. 4) to be bonded.

Leveling-bonding system 100 preferably includes mechanical parts (not shown) for moving bond head 20 and/or bond support 22 up and down. The forces applied to the wafers are also controllable. FIG. 3 also illustrates robot handler 30 for transferring wafers onto, and away from, bond support 22.

In the preferred embodiment, the leveling bonding is performed using foils. A foil may be disposable after being used in a leveling bonding. Accordingly, the foils are alternatively referred to as disposable foils throughout the description. The foils have sizes at least equal to, preferably slightly greater than, the sizes of the wafers to be leveling-bonded. FIG. 4 schematically illustrates foil dispatcher 34 for dispatching foil 36 onto wafer 40, which is the wafer to be leveling-bonded, and has dies 42 pre-bonded thereon. After being dispatched, foil 36 needs to cover all of the dies 42.

Foil 36 has a melting temperature higher than the temperature used for the leveling bonding. In addition, the hardness of foil 36 needs to be in an appropriate range. It is realized that dies 42 may have thickness variations due to the non-uniformity in the wafer thinning process before dies 42 are sawed from the respective wafers. The force applied by bond head 20 and bond support 22 (refer to FIG. 3) needs to be substantially uniformly applied to dies 42 through foil 36. Therefore, foil 36 needs to be hard enough to conduct the force, and soft enough to absorb (by having mis-shaping) the excess force applied on those dies 42 thicker than other others. In an exemplary embodiment, foil 36 is formed of aluminum, which has a melting temperature of about 660° C. In other embodiments, foil 36 is formed of a copper alloy, such as braze, which has a melting temperature of about 900° C. In yet other embodiments, foil 36 is formed of polymers, such as rubber, which may have temperatures of about 300° C. The thickness of foil 36 may be between about 20 μm and about 500 μm, for example. An advantageous feature of the present invention is that foil 36 is disposable, and hence appropriate foils may be conveniently selected depending on several factors, such as the types of wafers to be bonded, and whether the bonding between dies 42 and wafer 40 is an oxide-to-oxide bonding, a copper-to-copper bonding, or the like.

FIGS. 3 and 4 also illustrate control system 44, including a computer and program codes for controlling and coordinating the loading/un-loading of wafer 40, the movement and the heating of bond head 20 and/or bond support 22, and possibly the dispatching of foils.

In FIG. 4, dies 42 are shown as being pre-bonded onto wafer 40. Dies 42 are sawed from wafers, and are known-good-dies. Dies 42 may be bonded onto wafer 40 face-to-face, back-to-face, face-to-back, back-to-back, and the bond may be an oxide-to-oxide bond, oxide-to-silicon bond, metal-to-metal (also referred to as copper-to-copper) bond, and the like. The pre-bonding may be performed by placing each individual one of dies 42 onto wafer 40, and applying a force on the die for a short time, for example, several seconds. Heat may also be provided during the pre-bonding, for example, to between about 25° C. and about 400° C., depending on the type of bonds between dies 42 and wafer 40. After the pre-bonding, wafer 40 along with the pre-bonded dies 42 needs to go through a leveling bonding to strengthen the bonds.

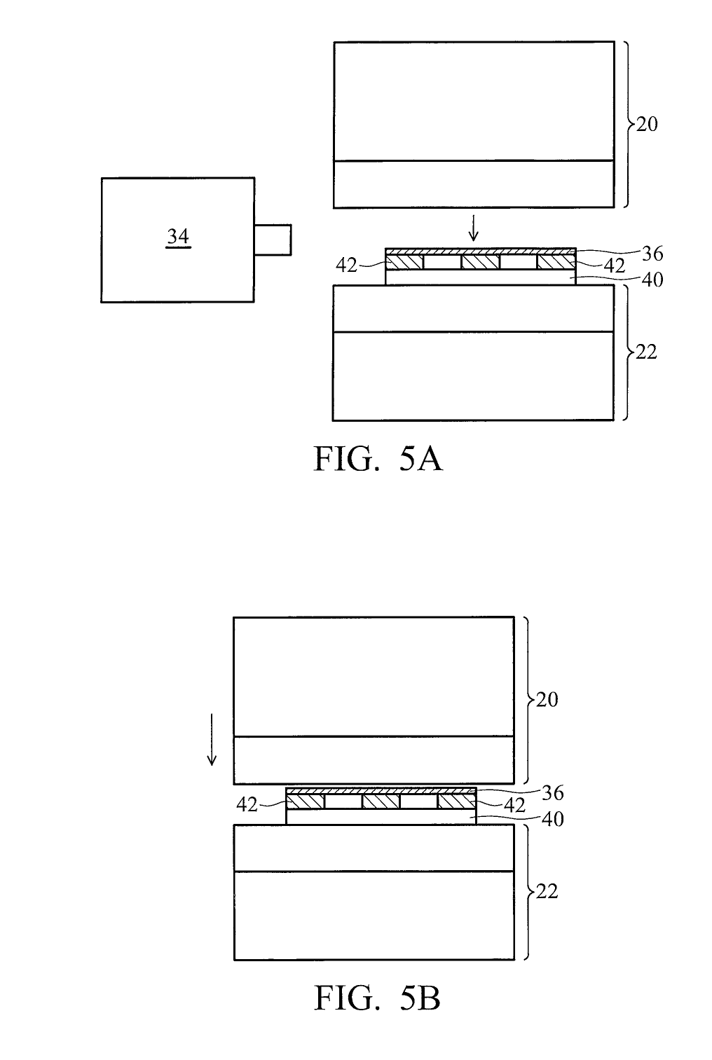

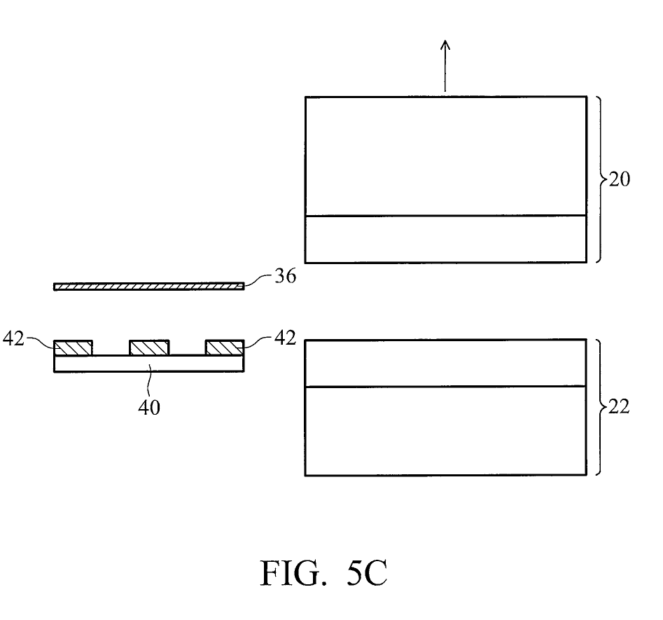

FIGS. 5A through 5C illustrate a first process flow of the present invention. Referring to FIG. 5A, foil 36 is first dispatched onto the pre-bonded dies 42 and wafer 40. No glue is used to glue foil 36 and dies 42. The desirable material of foil 36 depends on the required temperature in the subsequent leveling-bonding. For example, if the temperature is about 300° C. or less, foil 36 may be formed of polymers, copper, aluminum, or the like. If higher temperatures are required, the polymers may not be used. Instead, foil 36 is preferably formed of copper, aluminum, or the like. Next, as shown in FIG. 5B, the dispatched foil 36, dies 42, and wafer 40 are transferred into the controlled environment 24 by robot handler 30 (refer to FIG. 3), and placed between bond head 20 and bond support 22. During the leveling-bonding process, controlled environment 24 may be filled with clean air, nitrogen, or the like. It can also be vacuumed.

Referring again to FIG. 5B, the leveling bonding is performed by pressing bond head 20 against bond support 22, so that a force is applied on foil 36, dies 42, and wafer 40. Again, no glue is placed on the top surface of foil 36. Depending on the bonding method (such as oxide-to-oxide bonding, copper-to-copper bonding, and the like), the required force and the temperature of bond head 20 and/or bond support 22 are different. In an exemplary embodiment, the applied force may be between about 10 pounds per square inch (psi) and about 100 psi. The required temperature for direct copper-to-copper bonding may be over about 300° C., for example, between about 300° C. and about 500° C. The required temperature for direct oxide-to-oxide bonding may be less than about 300° C. An exemplary duration of the leveling bonding is between about 10 minutes and about 60 minutes.

In FIG. 5C, bond head 20 is released from foil 36, and then foil 36 is removed from over dies 42, and may be disposed. Wafer 40 is removed from controlled environment 24, and another wafer can be bonded.

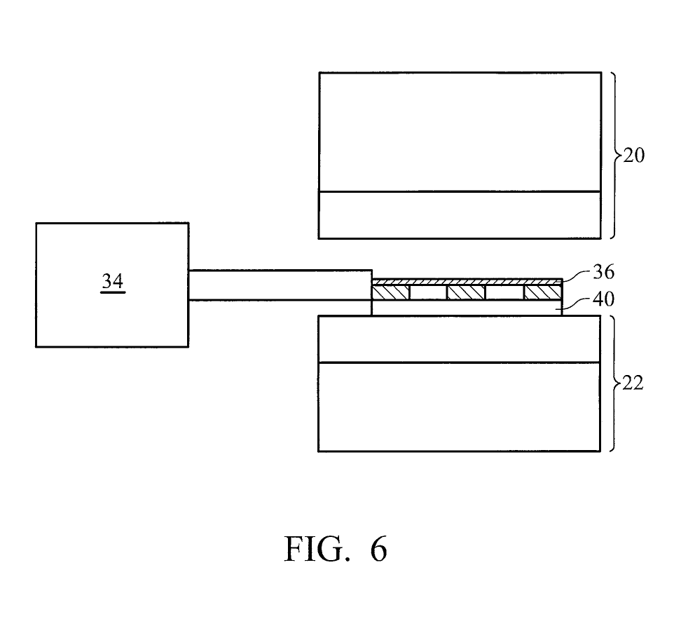

FIG. 6 illustrates an intermediate stage in another process flow. This embodiment is similar to the embodiment shown in FIGS. 5A through 5C, except the dispatching of foil 36 is performed after wafer 40 has been placed on bond support 22. In this embodiment, dies 42 and wafer 40 are pre-bonded, transferred into environment 24 by robot handler 30 (refer to FIG. 3), and then placed between bond head 20 and bond support 22. Foil dispatcher 34 then dispatches foil 36 onto dies 42. The subsequent leveling-bonding processes are essentially the same as shown in FIGS. 5B and 5C, and hence are not repeated herein.

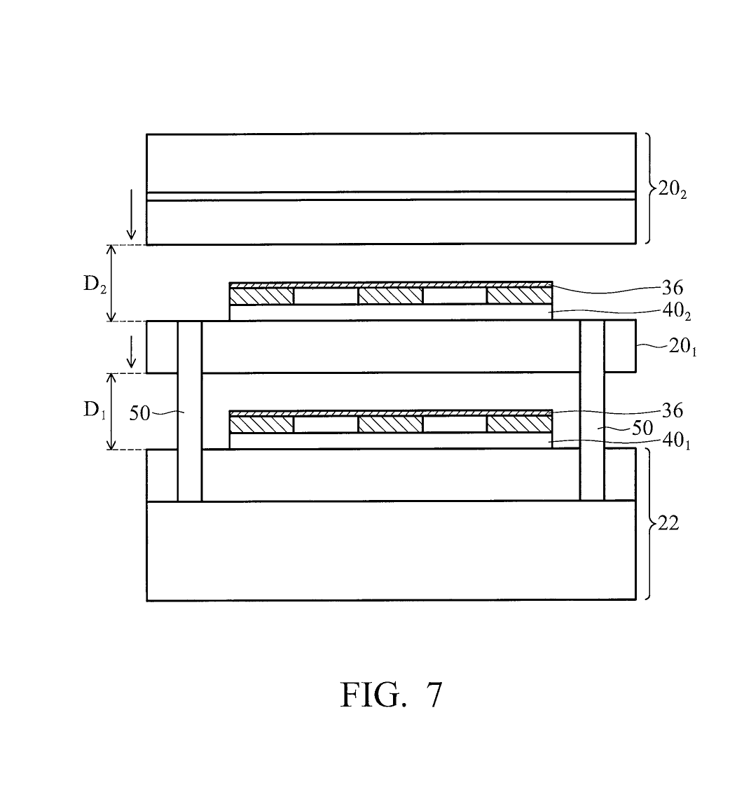

The embodiments of the present application include a multi-bond-head design. FIG. 7 illustrates an exemplary embodiment, which includes bond head 20₁, and bond head 20₂ over bond head 20₁. Bond heads 20₁, 20₂, and/or bond support 22 may be heated individually or simultaneously, and to a same temperature or different temperatures. Movement guides 50 may be used to connect bond head 20₁ and bond support 22, and used to guide the movement of bond head 20₁. Bond head 20₁ serves as the bond support for the wafers placed thereon, and may further include additional bond support components (not shown) for supporting the wafer placed thereon. The clearances D1 and D2 are adequate for loading/unloading wafers. The multi-bond-head system also includes robot handler 30 (refer to FIG. 3) and foil dispatcher 34 (refer to FIG. 4).

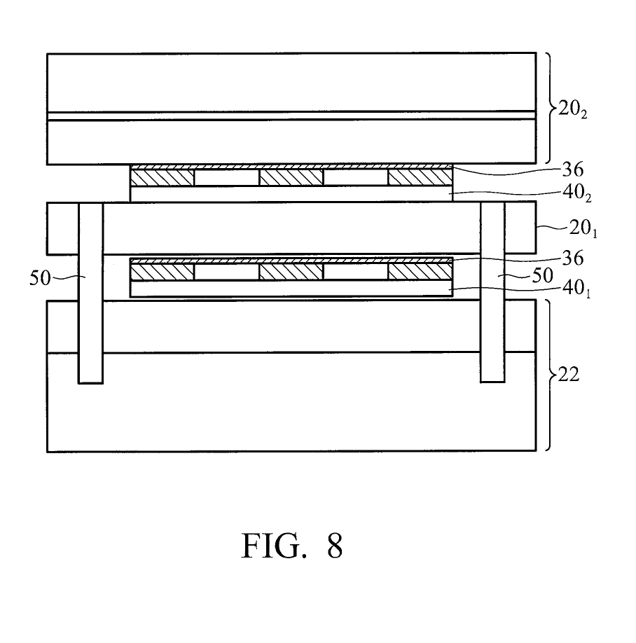

For operating the multi-bond-head system, wafers 40₁ and 40₂ are placed on bond support 22 and bond head 20, respectively, as shown in FIG. 7. Foils 36 are placed on wafers 40₁ and 40₂, either before, or after, wafers 40₁ and 40₂ are placed. When bond head 20₂ moves down, as shown in FIG. 8, wafer 40₂ is pressed, which causes bond head 20₁ to move down (confined or along movement guides 50), until the bottom of bond head 20₁ presses foil 36. The force applied by bond head 20₂ is thus conducted to wafer 40₂, bond head 20₁ and in turn presses wafer 40₁. Additional mechanical and/or electrical components (not shown) may be added to individually adjust the forces applied on wafers 40₁ and 40₂. Again, bond heads 20₁ and 20₂ may be heated to desirable, either the same, or different, temperatures.

By using the multi-bond-head embodiment as shown in FIG. 7, the throughput of the leveling bonding is doubled. In alternative embodiments, more bond heads/supports (such as three or more) may be stacked to bond more wafers simultaneously, so that the throughput of the leveling bonding can be further increased. Advantageously, wafers 40₁ and 40₂ may be, or may not be, identical to each other. Therefore, two wafers with different circuit design and/or sizes may be leveling-bonded simultaneously.

The embodiments of the present application have several advantageous features. Firstly, since foils 36 are disposable, no in-prints caused by one bonding will affect the subsequent bonding steps of other wafers. The reliability is thus improved. Secondly, with the flexibility of selecting appropriate foils, the leveling-bonding system of the present invention may be used for direct copper-to-copper bonding or other bonding applications requiring higher temperatures. Thirdly, multiple bond heads/supports can be stacked, so that the throughput may be increased.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An apparatus for bonding a wafer, the apparatus comprising:
a bond support for supporting the wafer;
a bond head over the bond support, wherein the bond support and the bond head are configured to move relative to each other; and
a foil dispatcher configured to dispatch a foil onto, and to remove the foil from over, the wafer.

2. The apparatus of claim 1, wherein a surface of the bond head facing the bond support is free from polymer materials.

3. The apparatus of claim 1 further comprising a control unit configured to control the bond head and the bond support to apply a pre-determined force against each other.

4. The apparatus of claim 1 further comprising a robot handler for loading the wafer onto, and unloading the wafer from, the bond support.

5. The apparatus of claim 1, wherein at least one of the bond head and the bond support is configured to heat the foil and the wafer.

6. The apparatus of claim 1, wherein the foil dispatcher is configured to dispatch foils having sizes no smaller than a size of the wafer.

7. (canceled)

8. The apparatus of claim 1 further comprising an additional bond head over the bond head, wherein the additional bond head and the bond head have a clearance for loading and unloading the wafer, and wherein the bond head and the additional bond head are configured to move relative to each other.

9. The apparatus of claim 8, wherein at least one of the additional bond head and the bond head is configured to heat a wafer placed between the bond head and the additional bond head.

10. The apparatus of claim 1, wherein the bond head has an area no smaller than a size of the foil.

11. An apparatus for bonding a wafer, the apparatus comprising:
a bond support for supporting the wafer;
a bond head over the bond support and having a surface facing the bond support, wherein the bond head is free from a polymer material;
a robot handler for loading the wafer onto, and unloading the wafer from, the bond support;
a foil free from adhesives on both sides, and having a size no smaller than a size of the wafer; and
a foil dispatcher configured to dispatch the foil onto, and to remove the foil from over, the wafer.

12. The apparatus of claim 11, wherein the bond head is configured to move against, and away from, the bond support to apply a force against the wafer.

13. The apparatus of claim 11, wherein at least one of the bond head and the bond support is configured to be heated to a pre-determined temperature.

14. The apparatus of claim 11 further comprising a chamber, wherein the bond head and the bond support are in the chamber.

15. (canceled)

16. The apparatus of claim 11 further comprising an additional bond head over the bond head, wherein the additional bond head and the bond head have a clearance for loading and unloading the wafer, and wherein the bond head and the additional bond head are configured to move relative to each other.

17. An apparatus for bonding a wafer, the apparatus comprising:
a bond support for supporting the wafer;
a first bond head over the bond support and having a surface facing the bond support, wherein the first bond head and the bond support are configured to move relative to each other;
a second bond head over, and having a clearance from, the first bond head, wherein the clearance is adequate for placing the wafer, and wherein the first and the second bond heads are free from polymer materials, and are configured to move relative to each other;
a robot handler for loading the wafer onto, and unloading the wafer from, at least one of the bond support and the first bond head; and
a foil dispatcher configured to dispatch a foil onto, and to remove the foil from over, the wafer, wherein the foil dispatcher is configured to dispatch wafer-size foils.

18. The apparatus of claim 17 further comprising a movement guide connecting the first and the second bond heads.

19. The apparatus of claim 17, wherein the first and the second bond heads are configured to be heated.
